(19) United States
(12) Patent Application Publication
(10) Pub. No.: US 2011/0090601 A1
(43) Pub. Date: Apr. 21, 2011

(54) Suspension with flexure tail and manufacturing method thereof, head stack assembly and disk drive unit with the same

(75) Inventor: Xianwen Feng, DongGuan (CN)

(73) Assignee: SAE Magnetics (H.K.) Ltd., Hong Kong (CN)

(21) Appl. No.: 12/656,625

(22) Filed: Feb. 4, 2010

(30) Foreign Application Priority Data
Oct. 16, 2009 (CN) 200910174813.1

(51) Int. Cl. G11B 21/16; G11B 27/36

(52) U.S. Cl. 360/245.8; 369/53.1; G9B/21.023; G9B/27.052

(57) ABSTRACT

A suspension for a head stack assembly, comprises a flexure with a suspension tongue, a flexure tail and a plurality of conductive traces extending between the suspension tongue and the flexure tail, each of said conductive traces having one end thereof terminated to an electrical pad formed on the suspension tongue for electrical connection to a slider and the other end thereof terminated to a connection pad formed on the flexure tail for both testing and bonding such that the flexure has no additional testing pads. The suspension with a flexure tail able to make the bonding and the dynamic performance testing on the pad area and thus reduce suspension length and increase flexure density for low cost. The invention also discloses a manufacturing method of the suspension and a HSA with such an suspension and a disk drive unit having such an HSA.

### FIELD OF THE INVENTION

The present invention relates to magnetic hard disk drive, and more particularly, to a head stack assembly with a suspension for dynamic performance testing and bonding.

### BACKGROUND OF THE INVENTION

One known type of information storage device is a disk drive device that uses magnetic media to store data and a movable read/write head that is positioned over the media to selectively read from or write to the disk.

FIG. 1 illustrates a conventional disk drive unit 100 and shows a series of magnetic disks 101 as medium for information/data storage mounted to and rotating round a spindle motor 102 at a high speed. A head stack assembly (HSA) 103 is rotating round an actuator bearing 106 for accessing data tracks on disks 105 during seeking. The HSA 103 includes an arm 105 and a head gimbal assembly (HGA) 104. The HGA 104 comprises a slider 108 containing a read/write head for electric/magnetic signal transform and a suspension 110 mounting on the slider 108. The HGA 104 is attached to the arm 105 which rotates round the bearing 106. A voice-coil motor (VCM) 107 is provided for controlling the rotation of the bearing 106 and further controlling the movement of the arm 105 and, in turn, controlling the slider 108 to move from track to track across the surface of the disks 101, thereby enabling the read/write head to read data from or write data to the disks 101. In operation, a lift force is generated by the aerodynamic interaction between the slider 108, incorporating the read/write head, and the spinning magnetic disks 101. The lift force is opposed by equal and opposite spring forces applied by the HGA 104 such that a predetermined flying height above the surface of the spinning disk 101 is maintained over a full radial stroke of the arm 105.

Now referring to FIG. 2, a conventional suspension 110 includes a load beam 111, a base plate 112, a hinge 113 and a flexure 114, all of which are assembled together. The load beam 111 is connected to the base plate 112 by the hinge 113. The flexure 114 is made of flexible material and runs from the hinge 113 to the load beam 111.

The flexure 114 comprises a distal end adjacent the load beam 111 for providing a slider mount area that the slider 108 is mounted on and a proximal end that defines a flexure tail configured for attachment to a Flexible Preamp Circuit (FPC) 109 via which the HGA connects with a servo control system (for example, a printed circuit board assembly, PCBA). The slider mount area forms a plurality of, such as four, electrical pads 115 thereon. The slider 108 is mounted on the slider mount area and has a plurality of connection pads electrically connecting the electrical pads 115. The electrical pads 115 and the connection pads are coupled by electrical connection balls (gold ball bonding or solder ball bonding, GBB or SBB). Similarly, the tail forms a plurality of such as six, connection pads 116 thereon. The FPC 109 is mounted on the tail and has a plurality of corresponding pads electrically connecting the connection pads 116. The connection pads 116 and the connection pads are coupled by electrical connection balls (gold ball bonding or solder ball bonding, GBB or SBB).

The flexure 114 further has a plurality of suspension traces 117 formed on the flexure 114 along length direction thereof. Each of said suspension traces 117 having one end thereof connected with the electrical pad 115 on the slider mount area and the other end thereof connected with the connection pad 116 on the flexure tail. Thus the control system can respectively control the slider 108 to read data from or write data to the disks 101 through the suspension traces 117. The combining of electrical pads 115, the connection pads 116 and the suspension traces 117 to form a flexure circuit. For the reading operation, the slider 108 function transforms electromagnetic record on the disk surface to the electrical signal and the signal transmits to computers system from the flexure circuit and the FPC 109. For the writing operation, it is contrary process and the slider 108 function transforms the electrical signal to electromagnetic record on the disk surface. So the flexure tail should contact the FPC to get a loop and transmits the signals which carry the data from computers system or the disk.

As more clearly illustrated in FIG. 3, the flexure tail has a plurality of connection pads 116 each having one end thereof connected with one of the suspension traces 117 via which the connection pads 116 connect with the electrical pad 115 (as shown in FIG. 2) on the slider mount area and the other end thereof connected with one of the suspension traces 117 via which the connection pads 116 connect a dynamic performance testing pad (not shown) to do dynamic performance testing during the manufacturing process. A dynamic performance testing must be performed to ensure that the semiconductor device is workable. After finishing the dynamic performance testing, the dynamic performance testing pads will be removed.

FIG. 4 is a flow chart of conventional method for manufacturing a HSA 103 with a suspension 110. FIGS. 5a-5b specifically shows how to forming a suspension 110 for a HSA 103 using the method shown in FIG. 4. Referring to FIG. 4, the conventional method of manufacturing the HSA comprises the steps of: providing a suspension 110 having a flexure 114 with a slider mount area, a flexure tail, and a plurality of suspension traces 117 extending between the suspension tongue and the flexure tail, each of said suspension traces 117 having one end thereof connected to an electrical pad 115 formed on the slider mount area for electrical connection to a slider and the other end thereof connected to a connection pad 116 formed on the flexure tail for bonding and extended to a testing pad 119 (refer to FIG. 5a) for testing (step S101); providing a slider, potting the slider onto the slider mount area of the flexure (step S102); performing dynamic performance testing of the suspension 110 by probing the testing pads 119 of the flexure tail (step S103); removing the testing pads 119 by cutting off the suspension traces 117 (refer to FIG. 5b) between the connection pads 116 and the testing pads 119 (step S104); providing a flexible preamp circuit and connecting the flexible preamp circuit to the connection pads 116 of the flexure tail of the suspension 110 (step S105).

However, in the process of forming a HSA 103 mentioned above, the connection pads 116 only use to bonding with the FPC in the process, but there need to do dynamic performance testing in the suspension forming process to ensure that the semiconductor device is workable, so there have additional area on flexure tail only for dynamic performance testing, which is the testing pads 119 and they will be removed after dynamic performance testing. So it will cause waste of resources and introduce a series of complex procedures. What's more, as the testing pads 119 removed, the suspension traces 117 which connect the connection pads 116 and the testing pads 119 will be cut off, and the end of the suspension traces 117 which connect nothing will produce electromagnetic interference (EMI). This affects the signals which transmitting in the flexure circuit, which in turn, affect slider's read/write ability of the assembled HSA 103.

Hence, a need has arisen for providing an improved a HSA with a suspension and its manufacturing method to solve the above-mentioned problems and achieve a good performance.

### SUMMARY OF THE INVENTION

Accordingly, an object of the present invention is to provide a suspension for a head stack assembly able to make the bonding and the dynamic performance testing on the same pad area, thereby reduce suspension length and increase suspension density for low cost.

A further object of the present invention is to provide a manufacturing method of a suspension for a head stack assembly able to make the bonding and the dynamic performance testing on the same pad area, thereby simplify working process.

Another object of the present invention is to provide a head stack assembly with a suspension able to make the bonding and the dynamic performance testing on the same pad area, thereby reduce suspension length and increase suspension density for low cost.

Still another object of the present invention is to provide a manufacturing method of a head gimbal assembly able to make the bonding and the dynamic performance testing on the same pad area, thereby simplify working process.

Still another object of the present invention is to provide a disk drive unit able to make the bonding and the dynamic performance testing on the same pad area, thereby reduce suspension length and increase suspension density for low cost.

To achieve the above-mentioned objectives, a suspension for a head stack assembly comprises a flexure having a suspension tongue, a flexure tail and a plurality of conductive traces extending between the suspension tongue and the flexure tail, each of said conductive traces having one end thereof terminated to an electrical pad formed on the suspension tongue for electrical connection to a slider and the other end thereof terminated to a connection pad formed on the flexure tail for both testing and bonding such that the flexure has no additional testing pads.

Preferably, the flexure comprises a base-metal layer and a dielectric layer laminated on the base-metal layer, and the connection pads are laminated on the dielectric layer.

Preferably, the flexure tail further has a further has a plurality of protective layers each covering one of the connection pads, and the protective layers are gold or nickel.

Preferably, the flexure tail further has a connection trace connecting the connection pads together for forming the protective layers to cover the connection pads by applying electrical current to the connection trace to galvanize the connection pads with gold or nickel, and the connection trace is etched to isolate the connection pads after forming the protective layer

Preferably, the flexure tail further has a plurality of thin dielectric layers each disposed between every two connection pads for supporting the trace.

Preferably, the flexure tail further has a plurality of covers disposed on the connection trace at positions adjacent to the connection pads so that only the exposed portions of the connection trace are etched.

Preferably, the base-metal layer has a free end defining a plurality of cutouts and each of the cutouts under the thin dielectric layers.

A manufacturing method of a suspension for a head stack assembly, comprising the steps of: providing a flexure with a suspension tongue and a flexure tail; forming a plurality of electrical pads on the suspension tongue configured for electrical connection to a slider; forming a plurality of connection pads on the flexure tail for both testing and bonding; and providing a plurality of conductive traces extending between the suspension tongue and the flexure tail, each of said conductive traces having one end thereof terminated to an the electrical pad and the other end thereof terminated to the connection pad.

Preferably, the flexure comprises a base-metal layer and a dielectric layer laminated on the base-metal layer, and the connection pads laminated on the dielectric layer.

Preferably, further comprising a step after the step of forming a plurality of connection pads laminated on the flexure tail: providing a connection trace connecting the connection pads together and applying electrical current to the connection trace to galvanize the connection pads with gold or nickel for forming a plurality of protective layers each covering one of the connection pads, and then etching the connection trace for isolating the connection pads.

Preferably, further comprising a step of forming a plurality of covers on the connection trace at positions adjacent to the connection pads before the step of etching the connection trace.

Preferably, further comprising a step of forming a plurality of thin dielectric layers each disposed between every two adjacent connection pads, and the connection trace being provided on the thin dielectric layers.

Preferably, the base-metal layer has a free end defining a plurality of cutouts under the thin dielectric layers.

A head stack assembly, comprises a slider, a suspension according to the suspension of the present invention, and a flexible preamp circuit connecting to the connection pads of the flexure tail of the suspension.

Preferably, the flexible preamp circuit is connecting to the connection pads by angle solder.

A manufacturing method of a head stack assembly comprising the steps of: providing a suspension according to the manufacturing method of a suspension of the present invention; providing a slider, potting the slider onto the suspension tongue of the flexure, and electrically connecting the electrical pads to the slider; testing the suspension by probing the connection pads of the flexure tail; and providing a flexible preamp circuit and connecting the flexible preamp circuit to the connection pads of the flexure tail of the suspension.

Preferably, the flexible preamp circuit is connecting to the connection pads by angle solder.

A disk drive unit, comprises a disk, a spindle motor operable to spin the disk, a head stack assembly and a flexible preamp circuit. The head stack assembly comprises a suspension with a flexure having a suspension tongue, a flexure tail and a plurality of conductive traces extending between the suspension tongue and the flexure tail, each of said conductive traces having one end thereof terminated to an electrical pad formed on the suspension tongue for electrical connection to a slider and the other end thereof terminated to an connection pad formed on the flexure tail for both testing and bonding such that the flexure has no additional testing pads. The flexible preamp circuit connecting to the connection pads of the flexure tail.

In comparison with the prior art, the present suspension for a head stack assembly not only can connect the flexure and the Flex Preamp Circuit with bonding for transmitting the signals in the loop circuit, but also can make the dynamic performance testing on the same pad area. The present suspension with a flexure able to make the bonding and the dynamic performance testing on the pad area, rather than use traditional dynamic performance testing pads, thereby reduce suspension length and increase suspension density for low cost. As the present invention has no additional dynamic performance testing pads, it need not to remove the additional dynamic performance testing pads after dynamic performance testing, thereby simplify working process.

In addition, as the present invention has no additional dynamic performance testing pads, it need not to remove the additional dynamic performance testing pads after dynamic performance testing, then the traces won't be cut off after dynamic performance testing, thus reduce electromagnetic interference (EMI) which affects the signals that transmitting in the flexure circuit, and in turn, the slider's read/write ability of the assembled HGA would be excellent.

Other aspects, features, and advantages of this invention will become apparent from the following detailed description when taken in conjunction with the accompanying drawings, which are a part of this disclosure and which illustrate by way of example, principles of this invention.

### BRIEF DESCRIPTION OF THE DRAWINGS

The accompanying drawings facilitate an understanding of the various embodiments of this invention. In such drawings:

FIG. 1 is a perspective view of a conventional disk drive unit;

FIG. 2 is a perspective view of a suspension of the disk drive unit shown in FIG. 1;

FIG. 3 is a partially enlarged view of the suspension shown in FIG. 2;

FIG. 4 is a flow chart showing a conventional method for manufacturing a HSA;

FIGS. 5a-5b specifically show how to forming the suspension for a HSA using the method shown in FIG. 4;

FIG. 6 is a perspective view of a first embodiment of a suspension for a head stack assembly according to the present invention;

FIG. 7 is a partial enlarged view of the suspension for a head stack assembly shown in FIG. 6;

FIG. 8 is a sectional view of the suspension shown in FIG. 7 taking along line A-A;

FIG. 9 is a partial enlarged view of the suspension for a head stack assembly shown in FIG. 8;

FIG. 10 is a partial enlarged view of a second embodiment of a suspension for a head stack assembly according to the present invention;

FIG. 11 is a partial enlarged view of a third embodiment of a suspension for a head stack assembly according to the present invention;

FIG. 12 is a sectional view of the suspension shown in FIG. 11 taking along line B-B;

FIG. 13 is a partial enlarged view of the suspension for a head stack assembly shown in FIG. 12;

FIG. 14 is a flow chart of manufacturing a suspension according to the present invention;

FIG. 15 is a perspective view of an embodiment of a head stack assembly according to the present invention;

FIG. 16 is a flow chart of manufacturing a HSA according to the present invention;

FIG. 17 is a perspective view of a disk drive unit according to the present invention.

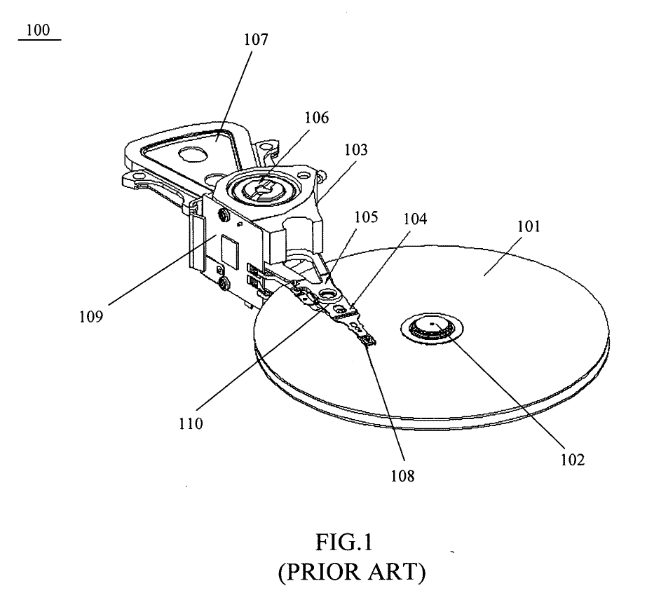

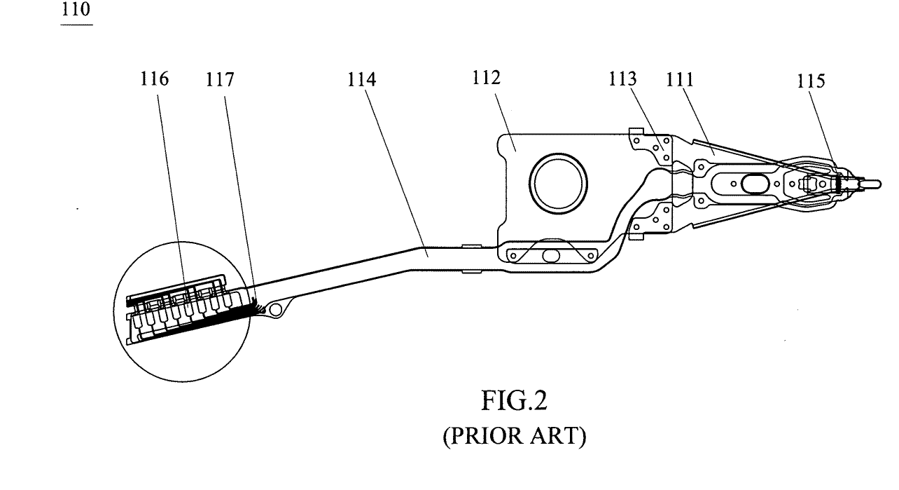

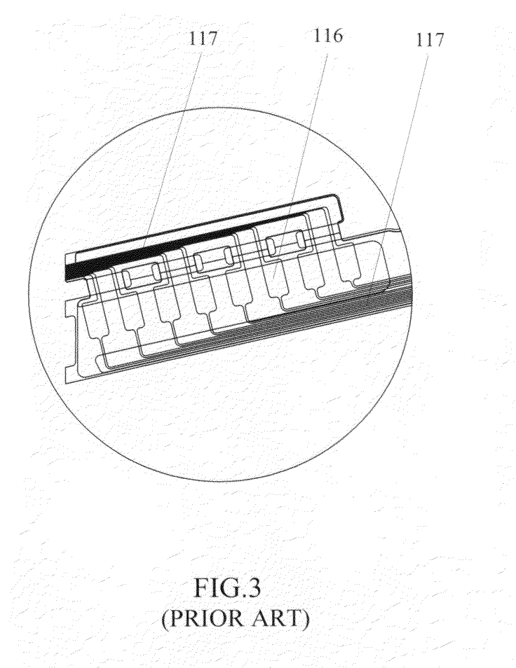

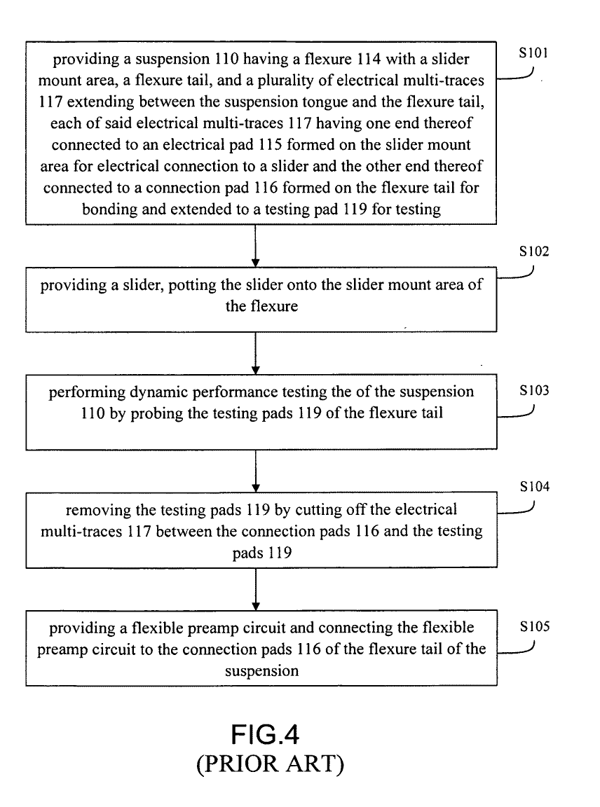

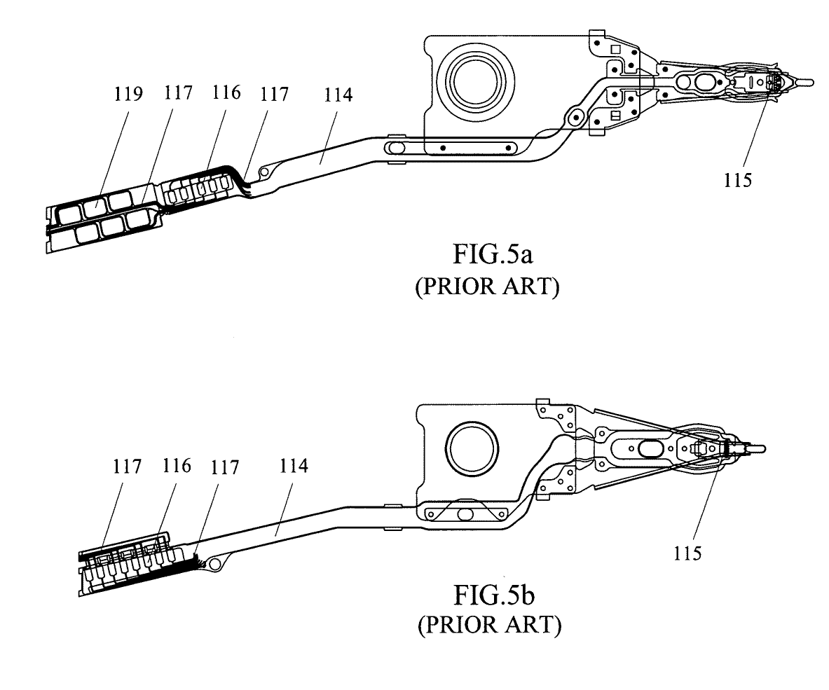

### DETAILED DESCRIPTION OF ILLUSTRATED EMBODIMENTS

Various preferred embodiments of the invention will now be described with reference to the figures, wherein like reference numerals designate similar parts throughout the various views.

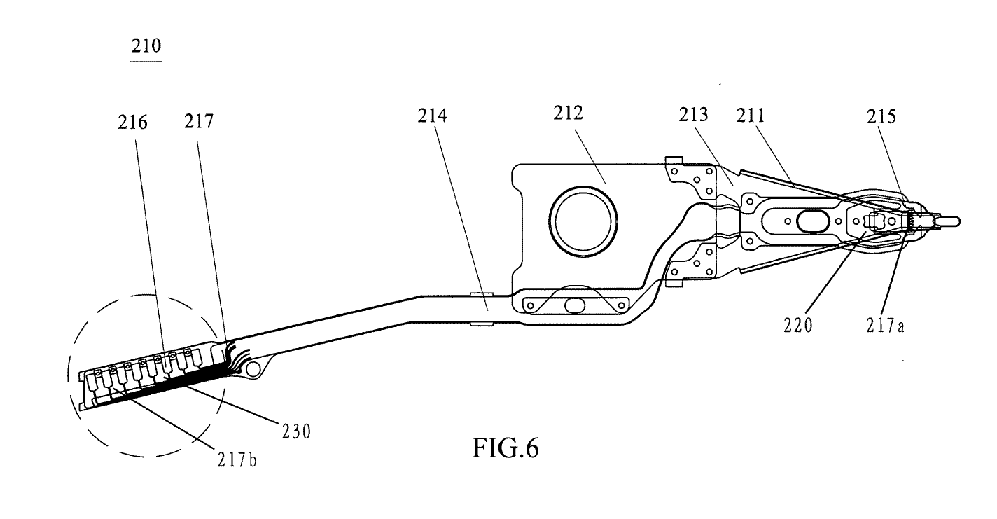

FIG. 6 is a perspective view of a first embodiment of a suspension for a head stack assembly according to the present invention. Referring to FIG. 6, the suspension 210 for a head stack assembly includes a load beam 211, a base plate 212, a hinge 213 and a flexure 214, all of which are assembled together. The load beam 211 is connected to the base plate 212 by the hinge 213. The flexure 214 runs from the hinge 213 to the load beam 211. The flexure 214 has a suspension tongue 220 with a plurality of electrical pads 215 formed thereon configured for electrical connection to a slider (not shown), a flexure tail 230 with a plurality of connection pads 216 configured for both testing and bonding, and a plurality of conductive traces 217 extending between the suspension tongue 220 and the flexure tail 230. Each of the conductive traces 217 has one end 217a thereof terminated to the electrical pad 215 formed on the suspension tongue 220 and the other end 217b thereof terminated to a connection pad 216 formed on the flexure tail 230 such that the flexure has no additional testing pads.

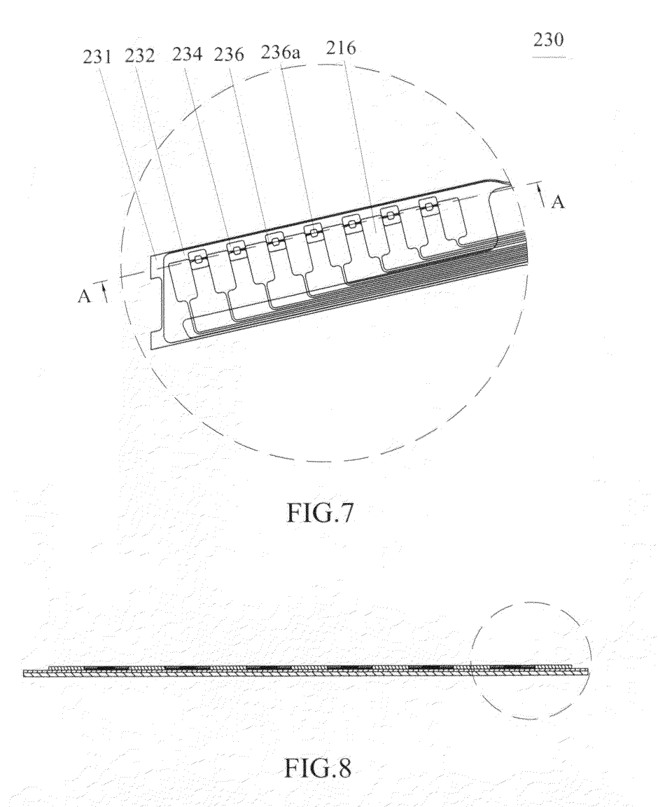

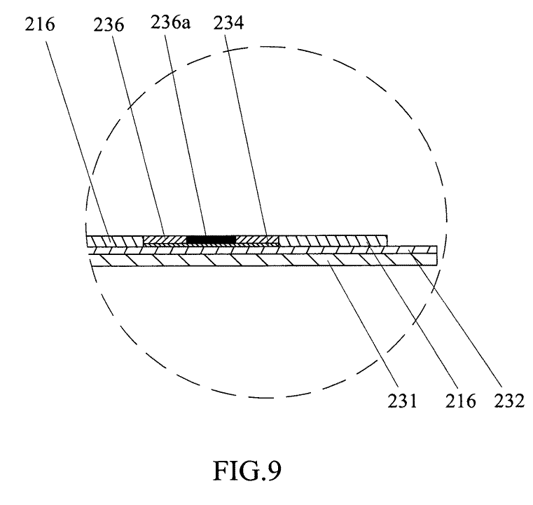

Now, referring to FIGS. 7-9, FIG. 7 is a partial enlarged view of the suspension for a head stack assembly shown in FIG. 6. FIG. 8 is a sectional view of the suspension shown in FIG. 7 taking along line A-A. FIG. 9 is a partial enlarged view of the suspension for the head stack assembly shown in FIG. 8. As illustrates, the flexure 214 has a laminar construction, in particular, the flexure 214 includes a base-metal layer 231 and a dielectric layer 232 laminated on the base-metal layer 231, and the connection pads 216 are laminated on the dielectric layer 232. In more particular, the base-metal layer 231 is comprised of stainless steel, the dielectric layer 232 is comprised of polyimide, and the connection pads 216 are comprised of copper, it should be understood that the connection pads 216 may be formed from other conductors such as silver, gold, or the like of combination thereof.

The flexure tail 230 further has a plurality of protective layers (not shown) each covering one of the connection pads 216 for preventing the connection pads 216 from oxidation. Preferably, the protective layers are comprised of gold or nickel. The flexure tail 230 further has a connection trace 236 connecting the connection pads 216 together for forming the protective layers above-mentioned to cover the connection pads 216 by applying electrical current to the connection trace 236 to galvanize the connection pads 216 with Au or Ni. The connection trace 236 is etched to isolate the connection pads 216 after forming the protective layers. Preferable, the flexure tail 230 further comprises a plurality of thin dielectric layers 234 each disposed between every two connection pads 216 for supporting the connection trace 236, that is to say, the connection trace 236 is disposed on the thin dielectric layers 234 and connect the connection pads 216 together.

It should be understood that the connection pads 216 will be isolated by etching the connection trace 236 after plating. In the case that the connection pads 216 will be used for dynamic performance testing and then be used for bonding which connect the flexure 214 and FPC. Thereby, the present suspension 210 with a flexure 214 able to make the bonding and the dynamic performance testing on the connection pads 216, rather than use traditional dynamic performance testing pads, thus reduce suspension length and increase flexure density for low cost.

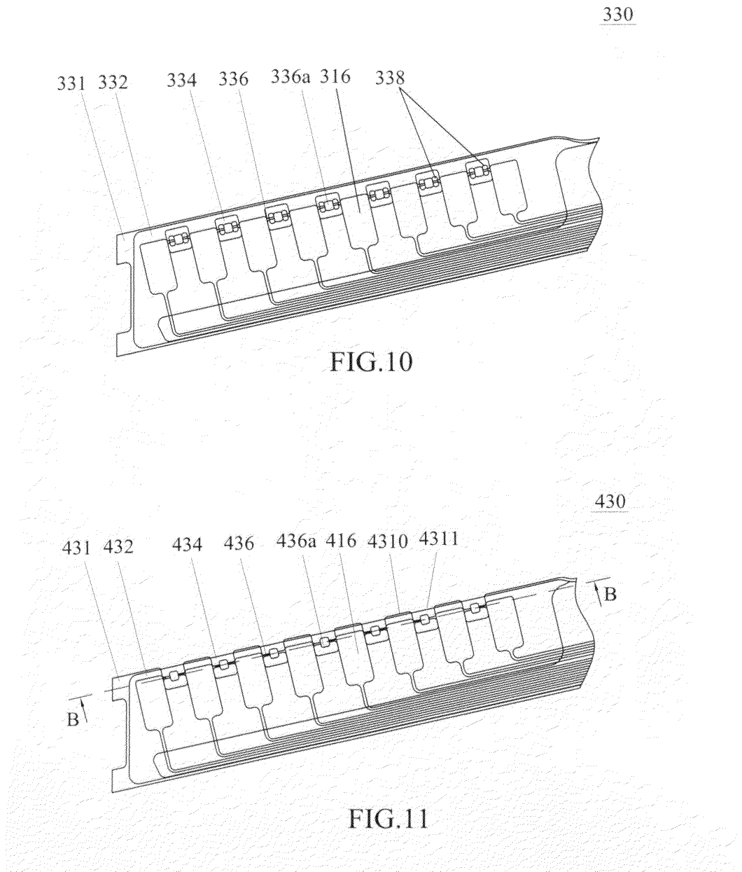

FIG. 10 illustrates a suspension for a head stack assembly of a second embodiment according to the present invention which is similar to the first embodiment that shown in FIG. 7. The flexure tail 330 includes a base-metal layer 331, a dielectric layer 332 laminated on the base-metal layer 331, a plurality of connection pads 316 laminated on the dielectric layer 332, a plurality of protective layers (not shown) each covering one of the connection pads 316, a connection trace 336 connecting the connection pads 316 together for forming the protective layers to cover on the connection pads 316, and a plurality of thin dielectric layers 334 each disposed between every two connection pads 316 for supporting the trace 336. The difference is in that the flexure tail 330 further has a plurality of covers 338 disposed on the connection trace 336 at positions adjacent to the connection pads 316 so that only the exposed portion 336a of the connection trace 336 are etched. When etching the connection trace 336 in order to isolate the connection pads 316, only the exposed portion 336a of the connection trace 336 are etched and thus prevent other portions of the flexure tail 330 (such as the connection pads 316, the dielectric layer 332 and so on) etching. What's more, the covers 338 can avoid the soldering tin attachment to the connection trace 336 when connecting the connection pads 316 to the FPC, which will affect the appearance of the flexure.

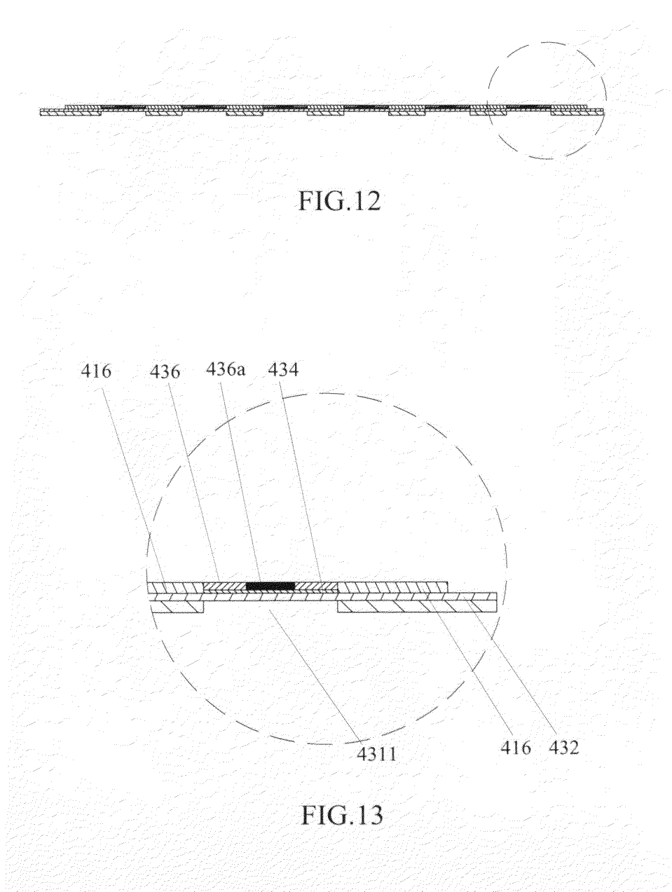

FIGS. 11-13 illustrates a suspension for a head stack assembly of a third embodiment according to the present invention which is similar to the first embodiment that shown in FIG. 7. The flexure tail 430 includes a base-metal layer 431, a dielectric layer 432 laminated on the base-metal layer 431, a plurality of connection pads 416 laminated on the dielectric layer 432, a plurality of protective layers (not shown) each covering one of the connection pads 416, a trace 436 connecting the connection pads 416 together for forming the protective layers to cover each of the connection pads 416 which is etched after forming the protective layers, and a plurality of thin dielectric layers 434 each disposed between every two connection pads 416 for supporting the trace 436. The difference is in that the base-metal layer 431 further has a free end 4310 defining a plurality of cutouts 4311 under the thin dielectric layers 434. For angle solder bonding, the free end 4160 of the connection pads 416 close to the free end 4310 of the base-metal layer 431 can facilitate bonding the pads 416 to connect the flexure and the FPC, so it's desired to shorten the distance between the free end 4160 of the connection pads 416 and the free end 4310 of the base-metal layer 431. But it's well known to persons ordinarily skilled in the art, the distance of the edge of the free end 4160 of the connection pads 416 and the edge of the free end 4310 of the base-metal layer 431 must be retained not too small as to prevent the connection pads 416 contacting with the base-metal layer 431, which do harm to the effect of the connection pads 436. So the cutouts 4311 act for facilitating the connection pads 416 bonding to connect the flexure and the FPC and prevent the pads 416 contacting with the base-metal layer 431 at the same time.

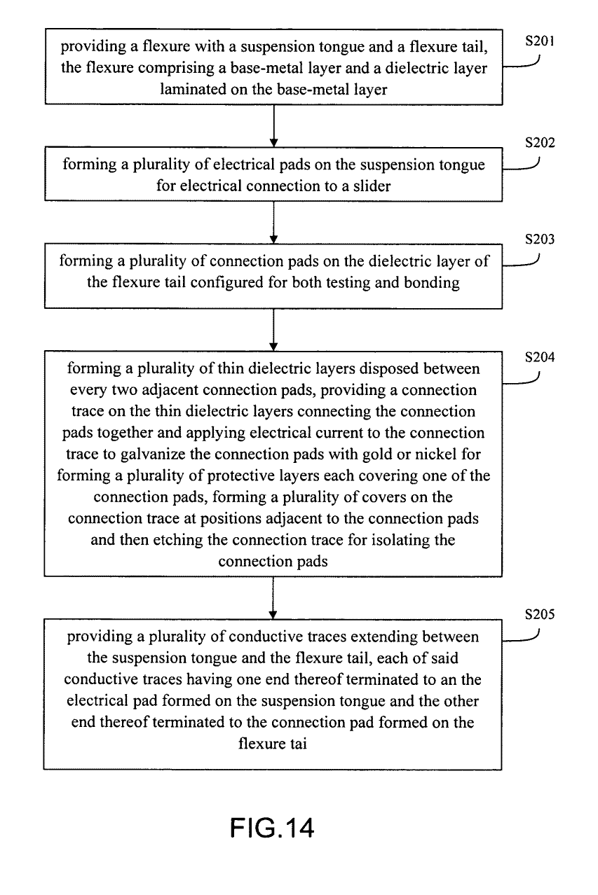

Referring to FIG. 14, a method of forming a suspension for a head stack assembly comprises the steps of: providing a flexure with a suspension tongue and a flexure tail, the flexure comprising a base-metal layer and a dielectric layer laminated on the base-metal layer (shown as step S201); forming a plurality of electrical pads on the suspension tongue configured for electrical connection to a slider (shown as step S202); forming a plurality of connection pads on the dielectric layer of the flexure tail configured for both testing and bonding (shown as step S203); forming a plurality of thin dielectric layers each disposed between every two adjacent connection pads, providing a connection trace on the thin dielectric layers connecting the connection pads together and applying electrical current to the connection trace to galvanize the connection pads with gold or nickel for forming a plurality of protective layers each covering one of the connection pads, forming a plurality of covers on the connection trace at positions adjacent to the connection pads and then etching the connection trace for isolating the connection pads (shown as step S204); and providing a plurality of conductive traces extending between the suspension tongue and the flexure tail, each of said conductive traces having one end thereof terminated to an the electrical pad formed on the suspension tongue and the other end thereof terminated to the connection pad formed on the flexure tail (shown as step S205).

Preferably, the base-metal layer has a free end defining a plurality of cutouts under the thin dielectric layers.

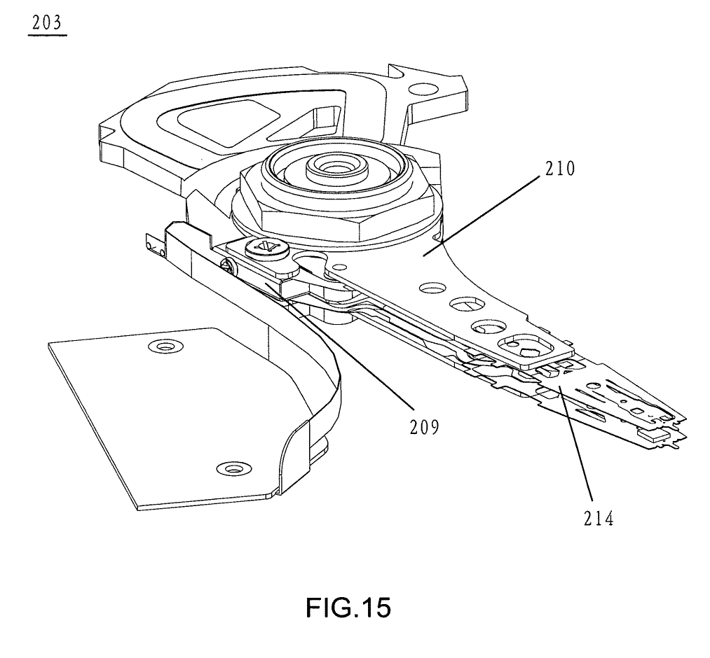

Now, referring to FIG. 15, a HSA 203 according to an embodiment of the invention comprises a suspension 210 and a flexible preamp circuit (FPC) 209. The suspension 210 has a flexure 214 with a suspension tongue, a flexure tail and a plurality of conductive traces extending between the suspension tongue and the flexure tail, each of said conductive traces having one end thereof terminated to an electrical pad formed on the suspension tongue for electrical connection to a slider and the other end thereof terminated to an connection pad formed on the flexure tail for both testing and bonding such that the flexure has no additional testing pads. The flexible preamp circuit is connecting to the connection pads formed on the flexure tail by angle solder. As the structure of the suspension 210 has been described in detail above, a detailed description of such structure and assembly is omitted herefrom. It is noted that the flexure tail may be any one of the flexure tail 230, 330 or 430 of the embodiments described above.

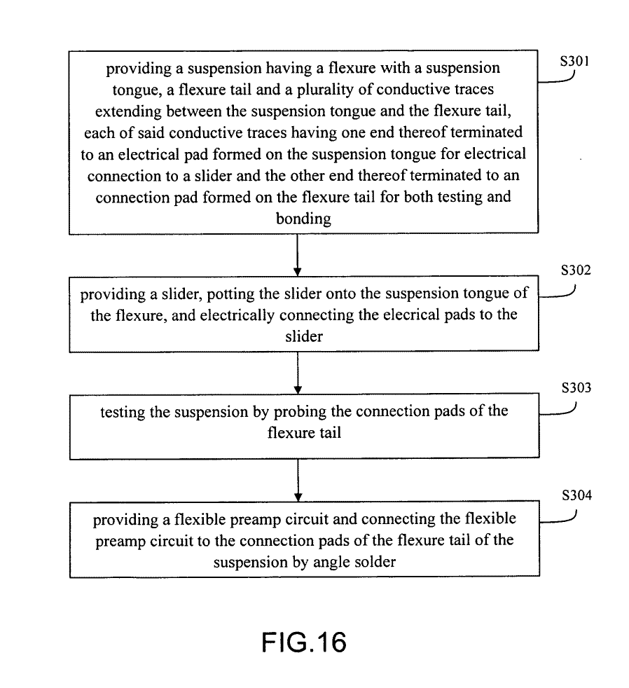

Referring to FIG. 16, a method of forming the HSA 203 comprises the steps of: providing a suspension having a flexure with a suspension tongue, a flexure tail and a plurality of conductive traces extending between the suspension tongue and the flexure tail, each of said conductive traces having one end thereof terminated to an electrical pad formed on the suspension tongue for electrical connection to a slider and the other end thereof terminated to an connection pad formed on the flexure tail for both testing and bonding (shown as step S301); providing a slider, potting the slider onto the suspension tongue of the flexure, and electrically connecting the electrical pads to the slider (shown as step S302); testing the suspension by probing the connection pads of the flexure tail (shown as step S303); providing a flexible preamp circuit and connecting the flexible preamp circuit to the connection pads of the flexure tail of the suspension by angle solder (shown as step S304).

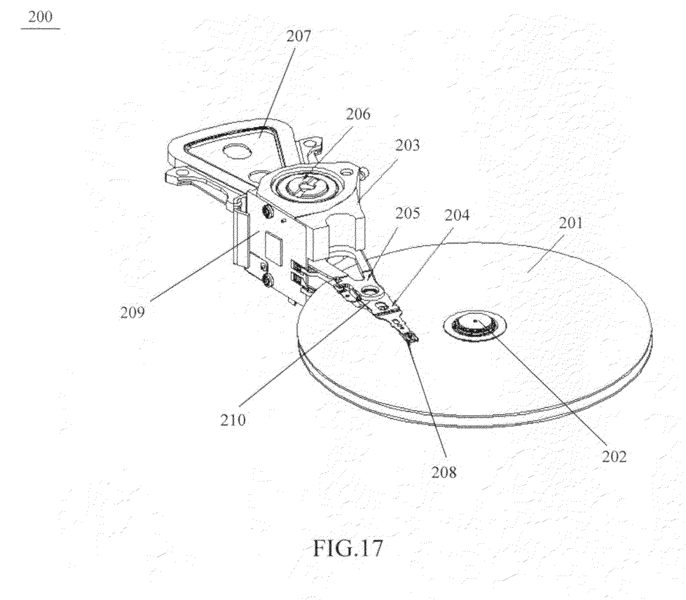

FIG. 17 shows a disk drive unit according to an embodiment of the invention. The disk drive unit 200 comprises a HSA 203, a drive arm 205 connected to the HSA 203, a disk 201, and a spindle motor 202 to spin the disk 201, all of which are mounted in a housing (not shown). Because the structure and/or assembly process of disk drive unit of the present invention are well known to persons ordinarily skilled in the art, a detailed description of such structure and assembly is omitted herefrom.

The foregoing description of the present invention has been presented for purposes of illustration and description. It is not intended to be exhaustive or limit the invention to the precise form disclosed, and obviously many modifications and variations are possible in light of the above teaching. Such modifications and variations that may be apparent to those skilled in the art are intended to be included within the scope of this invention as defined by the accompanying claims.

1. A suspension for a head stack assembly, comprising:
a flexure having a suspension tongue, a flexure tail and a plurality of conductive traces extending between the suspension tongue and the flexure tail, each of said conductive traces having one end thereof terminated to an electrical pad formed on the suspension tongue for electrical connection to a slider and the other end thereof terminated to a connection pad formed on the flexure tail for both testing and bonding such that the flexure has no additional testing pads.

2. The suspension as claimed in claim 1, wherein the flexure comprises a base-metal layer and a dielectric layer laminated on the base-metal layer, and the connection pads are laminated on the dielectric layer.

3. The suspension as claimed in claim 2, wherein the flexure tail further has a plurality of protective layers each covering one of the connection pads, and the protective layers are gold or nickel.

4. The suspension as claimed in claim 3, wherein the flexure tail further has a connection trace connecting the connection pads together for forming the protective layers to cover the connection pads by applying electrical current to the connection trace to galvanize the connection pads with gold or nickel, and the connection trace is etched to isolate the connection pads after forming the protective layers

5. The suspension as claimed in claim 4, wherein the flexure tail further has a plurality of thin dielectric layers each disposed between every two connection pads for supporting the connection trace.

6. The suspension as claimed in claim 4, wherein the flexure tail further has a plurality of covers disposed on the connection trace at positions adjacent to the connection pads so that only the exposed portions of the connection trace are etched.

7. The suspension as claimed in claim 5, wherein the base-metal layer has a free end defining a plurality of cutouts under the thin dielectric layers.

8. A manufacturing method of a suspension for a head stack assembly comprising the steps of:
providing a flexure with a suspension tongue and a flexure tail;
forming a plurality of electrical pads on the suspension tongue configured for electrical connection to a slider;
forming a plurality of connection pads on the flexure tail configured for both testing and bonding; and
providing a plurality of conductive traces extending between the suspension tongue and the flexure tail, each of said conductive traces having one end thereof terminated to the electrical pad and the other end thereof terminated to the connection pad.

9. The manufacturing method as claimed in claim 8, wherein the flexure comprises a base-metal layer and a dielectric layer laminated on the base-metal layer, and the connection pads are laminated on the dielectric layer.

10. The manufacturing method as claimed in claim 8, further comprising a step after the step of forming a plurality of connection pads laminated on the flexure tail:
providing a connection trace connecting the connection pads together and applying electrical current to the connection trace to galvanize the connection pads with gold or nickel for forming a plurality of protective layers each covering one of the connection pads, and then etching the connection trace for isolating the connection pads.

11. The manufacturing method as claimed in claim 10, further comprising a step of forming a plurality of covers on the connection trace at positions adjacent to the connection pads before the step of etching the connection trace, so that only the exposed portions of the connection trace are etched.

12. The manufacturing method as claimed in claim 10, further comprising a step of forming a plurality of thin dielectric layers each disposed between every two adjacent connection pads, and the connection trace being provided on the thin dielectric layers.

13. The manufacturing method as claimed in claim 12, wherein the base-metal layer has a free end defining a plurality of cutouts under the thin dielectric layers.

14. A head stack assembly, comprising:
a suspension as claimed in claim 1;
a flexible preamp circuit connecting to the connection pads of the flexure tail of the suspension.

15. The head stack assembly as claimed in claim 14, wherein the flexible preamp circuit is connecting to the connection pads of the flexure tail of the suspension by angle solder.

16. A manufacturing method of a head stack assembly comprising the steps of:
providing a suspension according to manufacturing method as claimed in claim 8;
providing a slider, potting the slider onto the suspension tongue of the flexure, and electrically connecting the electrical pads to the slider;
testing the suspension by probing the connection pads of the flexure tail; and
providing a flexible preamp circuit and connecting the flexible preamp circuit to the connection pads of the flexure tail of the suspension.

17. The manufacturing method as claimed in claim 16, wherein the flexible preamp circuit is connecting to the connection pads by angle solder.

18. A disk drive unit, comprising:
a disk;
a spindle motor operable to spin the disk;
a head stack assembly, comprising:
a suspension with a flexure having a suspension tongue, a flexure tail and a plurality of conductive traces extending between the suspension tongue and the flexure tail, each of said conductive traces having one end thereof terminated to an electrical pad formed on the suspension tongue for electrical connection to a slider and the other end thereof terminated to an connection pad formed on the flexure tail for both testing and bonding such that the flexure has no additional testing pads; and
a flexible preamp circuit connecting to the connection pads of the flexure tail.
